(19) United States
(12) Patent Application Publication
(10) Pub. No.: US 2012/0286952 A1
(43) Pub. Date: Nov. 15, 2012

(54) Method of identifying, distinguishing, and visually tracking survivors and non-survivors in the aftermath of a disaster

(76) Inventor: Juan Cienfuegos, San Antonio, TX (US)

(21) Appl. No.: 13/466,203

(22) Filed: May 8, 2012

Related U.S. Application Data
(60) Provisional application No. 61/518,641, filed on May 9, 2011.

(51) Int. Cl. G08B 1/08

(52) U.S. Cl. 340/539.13

(57) ABSTRACT

A method of locating, tracking, distinguishing and identifying people and pets as survivors or non survivors in the aftermath of a natural or manmade disaster, the method includes the use of illuminated displays such as flashlights, illuminated beacons, smart phone screens and/or computer screens. The illuminated displays are set to a particular color and flash pattern to distinguish between men, women, children, pets and whether they survived or not. When an alert is issued people prepare as they normally do but add one step. Tag or equip themselves and others with the illuminated displays set to the appropriate setting so that responders can utilize the night to locate the illuminate displays now recognized as indicators of people so they can better plan first light rescue operations.

This application is a continuation of provisional patent application No. 61/518,641, filed May 9, 2011

### FIELD OF THE INVENTION

This invention relates to a method for identifying survivors by utilizing illuminated displays. These illuminated displays are attached too or held by each person prior to a disaster striking. For example soon after an emergency tornado alert is sounded by the local authorities. The idea is to utilize the night to locate people who remained in the disaster affected area by searching for the illuminated displays that are attached too or held by each person or pet.

### BACKGROUND OF INVENTION

The object of the present invention is to provide for a new method of identifying survivors and non survivors. The illuminated displays are used to convey the location and status of each user in the aftermath of a natural disaster such as a tsunami, tornado, flood, hurricane etc . . .

Today there is a need for a system that will utilize the night to help locate survivors and non survivors in the aftermath of a disaster. Currently most search and rescue operations stop at night and people located in the disaster stricken area must wait for the day to start signaling there location and survival status in hopes of getting noticed. With today's technology there is no reason why we should not use the 12 dark hours of the 24 hour day to continue some form of search and rescue. This can be done by utilizing the smart phones or computer screens that most of us carry with us every day. Ideally products like the Emergency/Triage Lights which are more durable and last much longer, flashlights with white light and colored filters or flashlights having different colored LED's having different visible wavelengths such as white, red, yellow, green and/or blue would be utilized.

Notice every disaster scene that is seen on television remains constant, the images of the people on rooftops, car tops and trees waving trying to convey their location and the fact that they survived and are in need of help.

With the above image in mind I have developed the following method for Emergency/Triage Lights and other illuminated displays such as flashlights with colored filters, flashlights with multiple colored LED's, beacons with multiple colored lights, single colored lights, smart phone screens and/or computer screens to now empower populations to help first responders help them. It is a method of visually locating, tracking, distinguishing and triaging the locations of disaster site victims and casualties by utilizing lights and the night time hours to do so.

### SUMMARY OF THE INVENTION

The method of utilizing an illuminated display to locate and identify people or pets in the aftermath of disaster is implemented in the following manner. An alert is issued by a Local, State or Federal agency indicating a disaster is approaching or has occurred. For example a hurricane warning, a tsunami warning, a tornado warning, etc. . . . The population found in the area that is affected then starts to prepare for the disasters devastation to arrive. The new part of that preparation is equipping or attaching an illuminated display to each member of the family. Children are identified by solid red light, women are identified by solid green light, men are identified by solid blue light and pets are identified by yellow light. This is done hours or minutes before the disaster strikes. Once the disaster has passed and the person wearing or utilizing the illuminated display has survived, they then change their illuminated solid color to a flashing color to indicate they are survivors and in need of help. Non survivors would be identified by the illuminated displays that have not been changed to a flashing selection. The people who did survive and are not able to change the color selection from a solid to a flashing could move the illuminated display to show movement and therefore signal they are in need of assistance and are alive.

First responders now can identify surviving children by the flashing red illuminated displays, surviving women by the flashing green illuminated displays, surviving men by the flashing blue illuminated displays and pets by the solid or flashing yellow lights. This new method now allows for the night and the darkness to be utilized to aid first responders in locating and identifying non survivors and survivors for up to 2 weeks. Now the 12 hours of the day that are generally dark and not fully utilized are used to gather intelligence as to where people are located, the makeup of each group located. The condition of each group or individual located and are now able to preplan first light rescue operations accordingly.

### BRIEF DESCRIPTION OF THE DRAWING

FIG. 1 is an isometric view from the top illustrating an illuminated display system for placement on an user according to the present invention, the illuminated display system includes a plurality of light emitters that individually emit a predetermined wavelength band relating to the users identity (child, woman, man, pet) and condition (survivor, non survivor);

FIG. 2 is an orthographic view from the side illustrating one exemplary embodiment of an illuminated display system;

FIG. 3 are orthographic views from the top illustrating one exemplary embodiment of an illuminated display system, in particular, FIG. 3a is an orthographic view from the front illustrating a display interface of the illuminated display system, and FIG. 3b is an orthographic view from the top illustrating an illuminated display system having a fastening interface

FIG. 4 is a drawing of a single colored, multimode illuminated device using a rotary switch to select the appropriate mode of steady continuous light or flashing light.

FIG. 5 is a drawing of a single colored, multimode illuminated device using a pushbutton switch to select the appropriate mode of steady continuous light or flashing light.

FIG. 6 is a drawing of a mobile device screen utilizing an application to implement the illuminated display personal disaster identification method by changing the screen color to the appropriate color and mode for the circumstance.

FIG. 7 is a diagram of the personal disaster identification method

### DETAILED DESCRIPTION

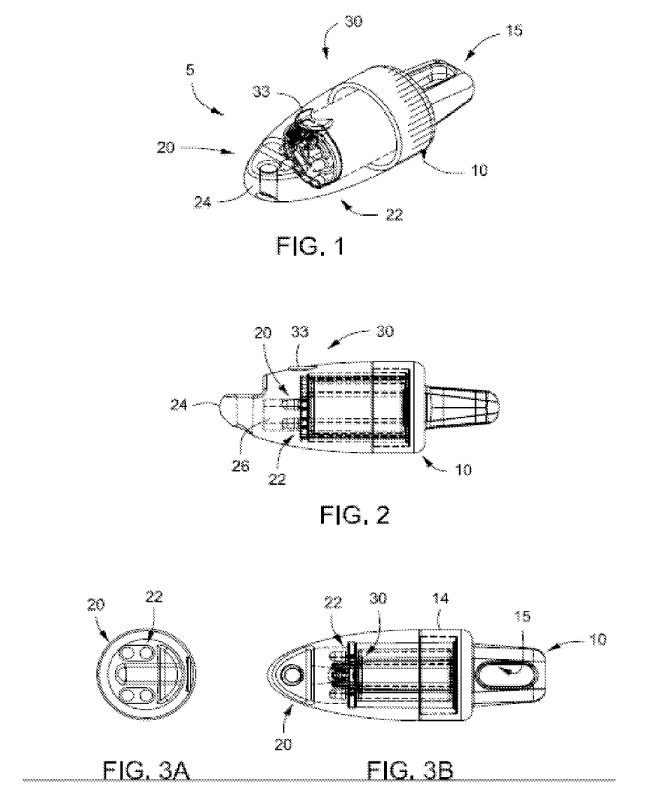

Referring to FIG. 1-3, there is shown an illuminated display system 30 for placement on a user according to the present invention. The illuminated display system incorporates four LED's 22, each LED 22 emitting a different wavelength of light, each wavelength of light conveying a different meaning. Illuminating the solid red selection indicates a child pre disaster. A flashing red selection indicates a surviving child post disaster. Illuminating a solid green selection indicates a woman pre-disaster. A flashing green indicates a surviving woman post disaster. Illuminating solid blue selection indicates a male pre-disaster. A flashing blue indicates a surviving male post disaster. The yellow is an optional selection and in this embodiment of the invention is used to tag a pet. It would be up to the owner to switch the selection to flashing to indicate the pet has survived. The yellow may originally be set to flash to increase the longevity of the battery.

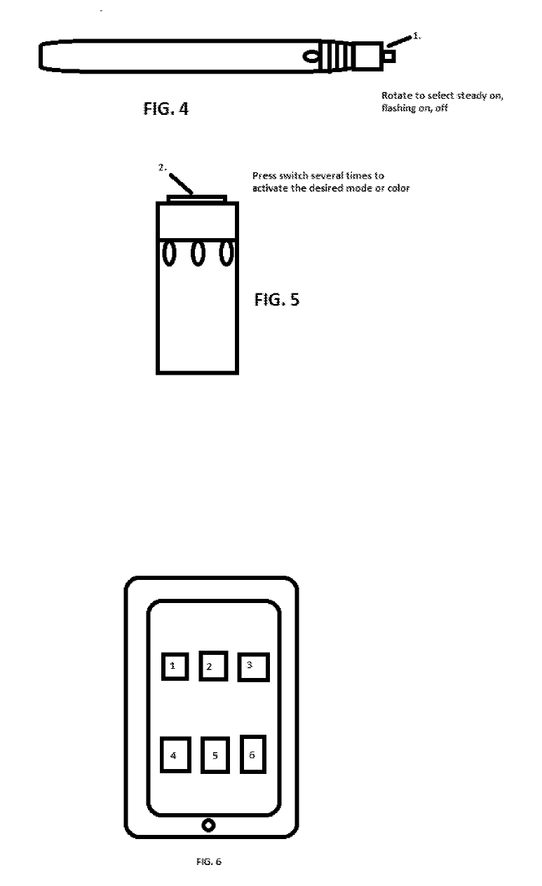

Referring to FIG. 4 there is shown an illuminated single colored, multimode (steady/flash) light for placement on a user or to be held by the user according to the present invention. The illuminated single colored, multi-mode light can be activated by rotating a switch 1 to the solid on selection and rotating it further to the flashing selection.

Referring to FIG. 5 there is shown a single colored, multimode light for placement on a user according to the present invention. The illuminated single colored, multi-mode light is activated by pressing a switch 2 to get to the desired mode selection, off, on, flashing, etc . . .

The illuminated, single colored, multimode light may also contain whistles, mirrors and other signaling methods attached or designed into the illuminated display.

Referring to FIG. 6 there is shown a mobile device utilizing a mobile application to utilize the method in case there is no time to go home and prepare. The mobile device user selects the application and is given the choice of selecting 1. Pre-disaster child (red), 2. pre-disaster woman (green), 3. pre-disaster man (blue), 4. Post disaster child (flashing red), 5. post disaster woman (flashing green) and 6. post disaster man (flashing blue). Once selected the mobile device displays the corresponding illuminated screen color and flash setting. The mobile device if capable would also send out a wifi, rfid, blue tooth or smart Bluetooth signal to further aid in pinpointing the location of the user utilizing the illuminated display from their mobile device. In fact the mobile device could send the users GPS location to selected friends when the mobile application is activated not only giving the user a signaling device but has sent out his locations when the mobile application is activated or updated.

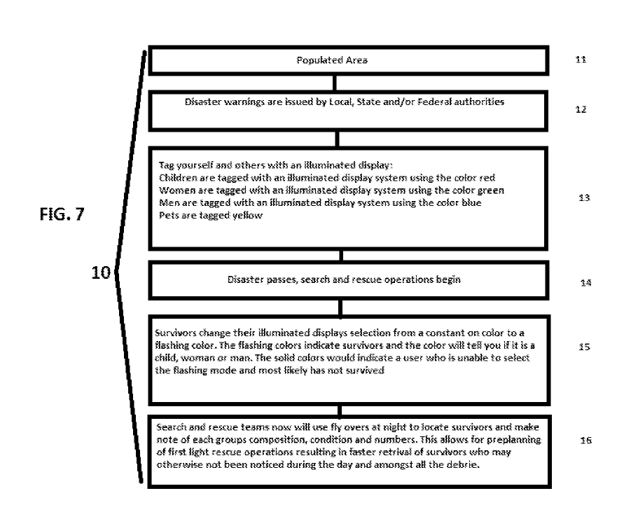

Referring to FIG. 7 a method 10 for visually locating and tracking disaster site victims may be appreciated as follows. You begin with a population 11 that is soon to be struck by a disaster. Disaster warnings 12 are issued and the population 11 gets prepared. Part of that preparation includes the tagging or equipping of each family member with an illuminated display 13. Children are equipped or tagged solid red illuminated displays prior to the disaster arriving. Women are equipped or tagged solid green illuminated displays prior to the disaster arriving. Men are equipped or tagged solid blue illuminated displays prior to a disaster arriving and pets are tagged yellow illuminated displays. Once the disaster has passed 14 the survivors switch 15 their illuminated displays to a flashing selection. By switching 15 to the flashing selection the user has accomplished two things. First the battery life is now extended and will allow the illuminated displays to illuminate brighter and longer. Second it will allow first responders to distinguish between non survivors and survivors thus allowing them to focus search and rescue efforts on the living (flashing) and at the same time flag or mark where non flashing illuminated displays are located. First responders can now utilize the illuminated displays to gather intelligence and better preplan 16 first light rescue operations thus reducing the time and costs associated with these endeavors, besides increasing the efficiency of the Search and Rescue teams.

Although the present invention has been described in detail, it should be understood that various changes, substitutions, and alterations could be made hereto without departing from the spirit and scope of the invention as defined by the appended claims.

1. A method for visually locating and tracking disaster site victims, the method comprising of:
the issuance of a disaster warning by Local, State or Federal authorities;
attaching an illuminated display to a person or pet located within the warning area;
each illuminated display includes a plurality of light emitters,
each light emitter providing a different wavelength of light than the other light emitters,
each respective wavelength providing information relating to a corresponding status of the user,
each desired light emitter is chosen for illumination thereof by a selector from the plurality of light emitters according to the lighting operation sequence
wait for the disaster to pass,
disaster passes and;
survivors switch the illuminated display to the appropriate setting according to the lighting operation sequence;
Providing visual status of each disaster victim according to the setting of each illuminated display.

2. The method according to claim 1 wherein the lighting operation sequence consists of identifying pre-disaster children with a red illuminated display, pre-disaster women with a green illuminated display, pre-disaster men with a blue illuminated display.

3. The method according to claim 1 wherein the operation sequence consists of identifying post disaster survivor children with a flashing red illuminated displays, post disaster survivor woman with a flashing green illuminated display and post disaster survivor man with a flashing blue illuminated display.

4. The method according to claim 1 wherein the operation sequence consists of identifying pets with a yellow illuminated display.

5. The method according to claim 1 wherein the flash rate to identify a survivor is between 50 and 70 pulses per minute.

6. The method according to claim 1 wherein the illuminated display has a lock feature to prevent the illuminated display from being inadvertently switched or turned off.

7. The method according to claim 1 wherein the illuminated display has a last selection memory to recall and return to the selected color even after power has been lost to the illuminated display system due to the adverse conditions found during a disaster.

8. The method according to claim 1 wherein the illuminated display is water resistant and/or waterproof.

9. The method according to claim 1 wherein the illuminated display is attached to the person by being held in the hand.

10. A method according to claim 1 wherein the illuminated display is a smart phone or computer screen.

11. A method for visually locating and tracking disaster site victims, the method comprising of:
the issuance of a disaster warning by Local, State or Federal authorities;
attaching an illuminated display to a person or pet located within the warning area;
each illuminated display includes at least one light emitter,
the light emitter provides at least one wavelength of light found in the lighting operation sequence,
each individual wavelength providing information relating to a corresponding status of the user,
each desired light emitter is chosen for illumination thereof by a selector
wait for the disaster to pass,
disaster passes and;
survivors switch the illuminated display to the appropriate setting according to the lighting operation sequence;
Providing visual status of each disaster victim according to the setting of each illuminated display.

12. The method according to claim 11 wherein the operation sequence consists of identifying pre-disaster children with a red illuminated display, pre-disaster women with a green illuminated display, pre-disaster men with a blue illuminated display.

13. The method according to claim 11 wherein the operation sequence consists of identifying post disaster survivor child with a flashing red illuminated display, post disaster survivor woman with a flashing green illuminated display and post disaster survivor man with a flashing blue illuminated display.

14. The method according to claim 11 wherein the operation sequence consists of identifying pets with a yellow illuminated display.

15. The method according to claim 11 wherein the flashing rate to identify a survivor is between 50 and 70 pulses per minute.

16. The method according to claim 11 wherein the illuminated display has a last selection memory to insure the illuminated display will stay on the selection even after losing power due to abuse received during the disaster.

17. The method according to claim 11 wherein the illuminated display has a lock feature to prevent the illuminated display from changing during the disaster.

18. The method of identifying pre-disaster children with the illuminated color red and post disaster surviving children with the flashing illuminated color red.

19. The method of identifying pre-disaster women with the illuminated color green and post disaster women with the flashing illuminated color green.

20. The method of identifying pre-disaster men with the illuminated color blue and post disaster survivor men with the flashing illuminated color blue.
